(19) United States
(12) Patent Application Publication
(10) Pub. No.: US 2013/0166326 A1
(43) Pub. Date: Jun. 27, 2013

(54) SYSTEM AND METHOD FOR CHARACTERIZING DRIVER PERFORMANCE AND USE IN DETERMINING INSURANCE COVERAGE

(71) Applicant: Scope Technologies Holdings Limited, Johannesburg (ZA)

(72) Inventors: Samuel Lavie, Johannesburg (ZA); Johann Van den Bergh, Johannesburg (ZA)

(73) Assignee: Scope Technologies Holdings Limited, Johannesburg (ZA)

(21) Appl. No.: 13/679,771

(22) Filed: Nov. 16, 2012

Related U.S. Application Data
(60) Provisional application No. 61/578,511, filed on Dec. 21, 2011.
(60) Provisional application No. 61/652,017, filed on May 25, 2012.

(51) Int. Cl. G06Q 40/08

(52) U.S. Cl. CPC G06Q 40/08
USPC 705/4

(57) ABSTRACT

A system and method for characterizing driver performance and using such characterization to determine a risk score and/or profile associated with a particular insured. In accordance with an embodiment, a driver can use a portable device equipped with a data collection and assessment environment, including one or more data collection devices and a data collection and assessment logic. The data collection and assessment environment can provide information to the driver about their driving performance, which the driver can then use to improve their driving skills. The information can also be used by the driver when obtaining liability insurance quotes. In accordance with an embodiment a framework (system) receives information about the driver's driving performance, and uses this information either to determine an insurance quote, or act as a broker/aggregator in inviting other insurance providers to offer an insurance quote.

### CLAIM OF PRIORITY

This application claims the benefit of priority to U.S. Provisional Patent Application titled “SYSTEM AND METHOD FOR USE OF PATTERN RECOGNITION IN ASSESSING OR MONITORING VEHICLE STATUS OR OPERATOR DRIVING BEHAVIOR”, Application No. 61/578,511, filed Dec. 21, 2011; and U.S. Provisional Patent Application titled “SYSTEM AND METHOD FOR CHARACTERIZING DRIVER PERFORMANCE AND USE IN DETERMINING INSURANCE COVERAGE”; Application No. 61/652,017, filed May 25, 2012; each of which above applications are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to telematics and related technologies, and are particularly related to a system and method for characterizing driver performance and its use in determining insurance coverage.

### BACKGROUND

Telematics generally refers to the integration of telecommunications and informatics, and is often described in the context of sending and receiving information about moving objects by means of telecommunication devices. A typical use of telematics is in fleet management, to enable tracking the location and operation of vehicles such as cars and trucks. However, information about a vehicle, together with its driver, also has a bearing on factors such as liability insurance. For example, heavily-used vehicles are on the road more often, which means they potentially have more exposure to accidents. Additionally, certain drivers may have driving habits that are considered less safe than others. Information about these and other factors is useful when formulating insurance quotes for a particular vehicle or driver. This is the general area that embodiments of the invention are intended to address.

### SUMMARY

Described herein is a system and method for characterizing driver performance and using such characterization to determine a risk score and/or profile associated with a particular insured. The risk profile/score can then be used to determine an insurance premium for the insured.

In accordance with an embodiment, a driver can use a portable device equipped with a data collection and assessment environment, including one or more data collection devices that can be used to capture data and information or otherwise measure vehicle actions, and a data collection and assessment logic. The data collection and assessment environment can provide information to the driver about their driving performance, which the driver can then use to improve their driving skills. The information can also be used by the driver when obtaining liability insurance quotes.

In accordance with an embodiment a framework (system) receives information about the driver's driving performance, and uses this information either to determine an insurance quote, or act as a broker/aggregator in inviting other insurance providers to offer an insurance quote. This allows the insurance quote to be better personalized to the driver themselves. In particular, the framework enables the driver to collect his own behavior data and provide that data to an insurer or insurance broker/aggregator, to receive a usage based insurance quote (UBI).

### BRIEF DESCRIPTION OF THE FIGURES

FIG. 1 illustrates a system for characterizing driver performance and use in determining insurance coverage, in accordance with an embodiment.

FIG. 2 illustrates use of a system for characterizing driver performance, in accordance with an embodiment.

FIG. 3 illustrates use of an insurance provider and/or broker framework, in accordance with an embodiment.

FIG. 4 is a flowchart of a method for characterizing driver performance and use in determining insurance coverage, in accordance with an embodiment.

### DETAILED DESCRIPTION

As described above, in the insurance industry, information about such factors as whether a driver of a vehicle observes safe driving habits is useful when formulating insurance quotes for a particular vehicle or driver.

To address this, described herein is a system and method for characterizing driver performance and using such characterization to determine a risk score and/or profile associated with a particular insured. The risk profile/score can then be used to determine an insurance premium for the insured. In accordance with an embodiment, a driver can use a portable device (e.g., a smartphone, PDA, computer or other device) equipped with a data collection and assessment environment, including one or more data collection devices (e.g., accelerometers, GPS) that can be used to capture data and information or otherwise measure vehicle actions, and a data collection and assessment logic (e.g., a downloadable software application).

The data collection and assessment environment can provide information to the driver about their driving performance, such as whether they make rapid braking/acceleration maneuvers, or drift outside of their lane, which the driver can then use to improve their driving skills.

The information can also be used by the driver when obtaining liability insurance quotes. In accordance with an embodiment a framework (system) receives information about the driver's driving performance, and uses this information either to determine an insurance quote, or act as a broker/aggregator in inviting other insurance providers to offer an insurance quote. This allows the insurance quote to be better personalized to the driver themselves. In particular, the framework enables the driver to collect his own behavior data and provide that data to an insurer or insurance broker/aggregator, to receive a usage based insurance quote (UBI).

In accordance with an embodiment, the system and the driver performance information can be used to augment traditional insurance application questionnaires. The information received from a driver's data collection and assessment environment can be secured and/or anonymized prior to determining the driver's insurance quote, or inviting other insurance providers to offer an insurance quote.

In a typical implementation, a less-safe (i.e., “bad”) driver, as determined by their driving performance, may not receive any benefit in providing their information. However, a safer (i.e., “good”) driver, as determined by their driving performance, may receive a discount on their insurance quote that reflects their better performance. In accordance with an embodiment, the framework can also be used to consider periodic improvements, and provide additional insurance discounts to the driver over time.

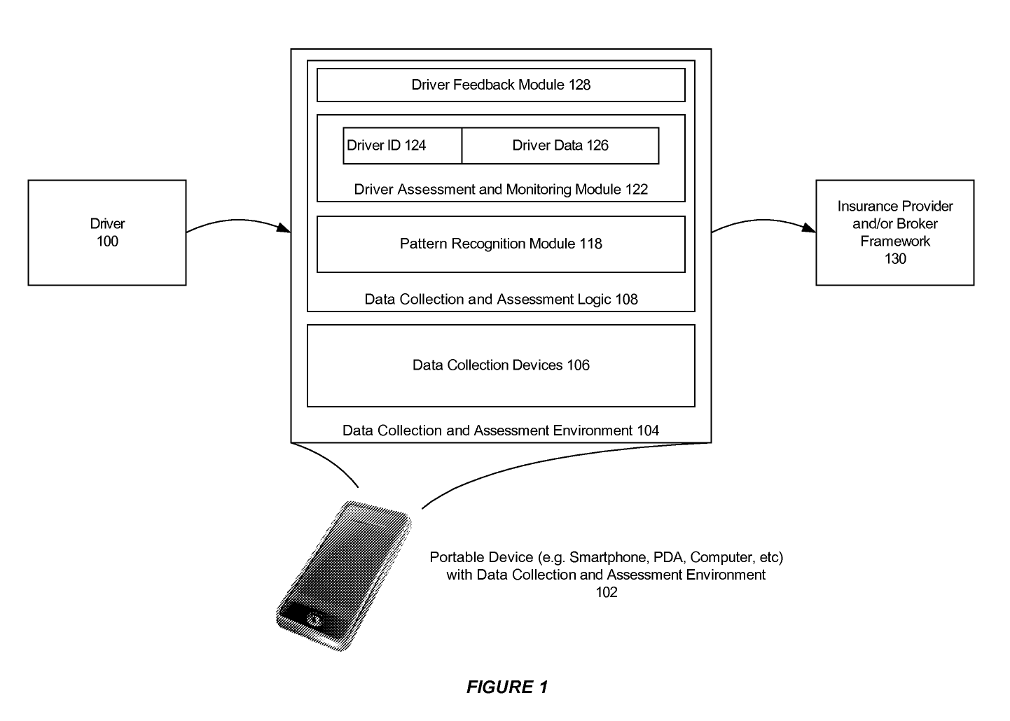

FIG. 1 illustrates a system for characterizing vehicle driver performance and use in determining insurance coverage, in accordance with an embodiment.

As shown in FIG. 1, in accordance with an embodiment, a driver 100, can use a portable device 102 (e.g., a smartphone, PDA, computer, or other device) which is equipped with a data collection and assessment environment 104. In accordance with an embodiment, the portable device can itself include one or more data collection devices 106 (e.g., accelerometers, GPS, or other measurement devices) that can be used to capture data and information or otherwise measure vehicle actions. In accordance with other embodiments the data collection devices can be added to the portable device, e.g., as an aftermarket accessory.

A data collection and assessment logic 108 can similarly be built-into the portable device, or added as an aftermarket accessory, e.g., as a downloadable software application (app).

A pattern recognition module 118 is configured with one or more defined operating patterns, each of which operating patterns reflects either a known change in vehicle status, or a known vehicle operating or driving behavior. For example, a vehicle responds in a physically-measurable manner to driver-based driving actions, e.g., by the driver turning the vehicle sharply at a corner. This enables the system to associate patterns with a driver's driving behavior, and to determine a risk score and/or profile associated with a particular driver. Sequences of patterns can be used to reflect changes both in the vehicle status and in the driver's performance, i.e., their driving behavior over a period of time, say from the time a driver embarks the vehicle, through a series of driving maneuvers, up until the time they disembark the vehicle, or over a period of days, weeks or months.

In accordance with an embodiment, a driver assessment and monitoring module 122 includes information about one or more drivers, including for each driver an identifier (ID) 124 and additional data or information 126 describing that driver and/or their typical operating characteristics. A driver feedback module 128 can be used to provide immediate or local feedback to the driver depending on their current vehicle status and/or driving performance.

The resultant information, pattern matching, or driver feedback can be remotely communicated to an external insurance provider and/or broker framework (system) 130, which uses the received information in determining insurance quotes for a particular vehicle or driver, or inviting other insurance providers to offer an insurance quote for the particular vehicle or driver. In particular, the framework enables the driver to collect his own behavior data and provide that data to an insurer or insurance broker/aggregator, to receive a usage based insurance quote (UBI).

In accordance with an embodiment, the system can incorporate or utilize additional functionality as further described in U.S. Provisional Patent Application titled “SYSTEM AND METHOD FOR USE OF PATTERN RECOGNITION IN ASSESSING OR MONITORING VEHICLE STATUS OR OPERATOR DRIVING BEHAVIOR”, Application No. 61/578,511, filed Dec. 21, 2011, and herein incorporated by reference.

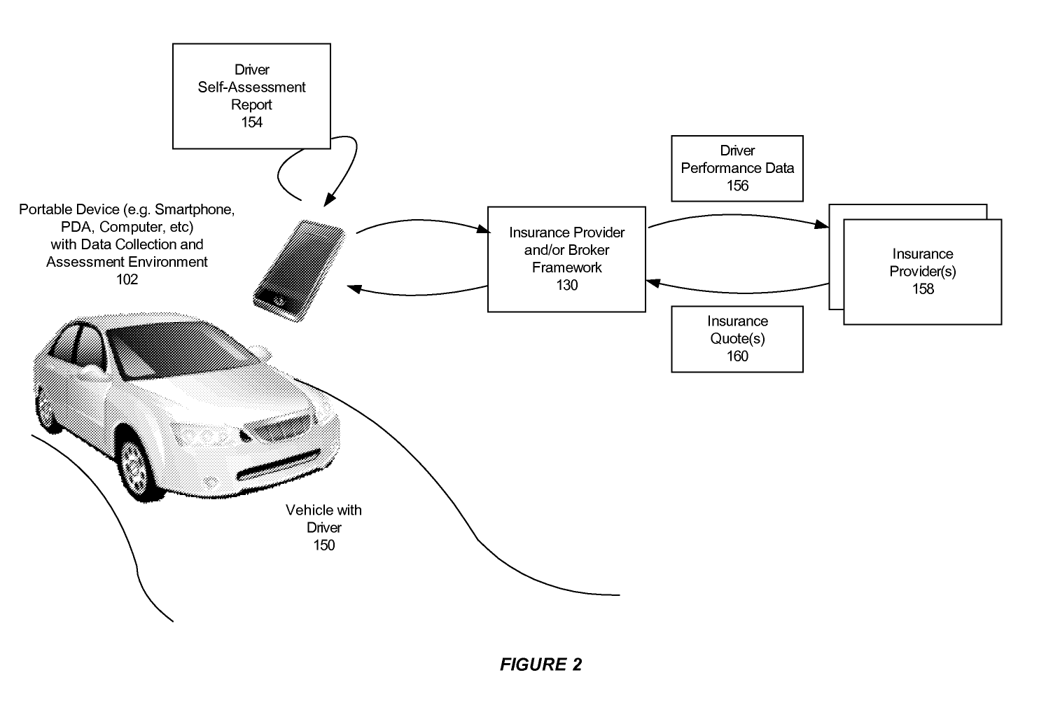

FIG. 2 illustrates use of a system for characterizing driver performance, in accordance with an embodiment. As shown in FIG. 2, during use, a driver of a vehicle 150 can use their portable device (e.g., a smartphone, PDA, computer, or other device) suitably equipped with a data collection and assessment environment, to track their driving performance, either for their own use 154, or to communicate the information to an insurance provider and/or broker framework for use in determining an insurance quote, or act as a broker/aggregator in inviting 156 other insurance providers 158 to offer 160 an insurance quote. This allows the insurance quote to be better personalized to the driver themselves.

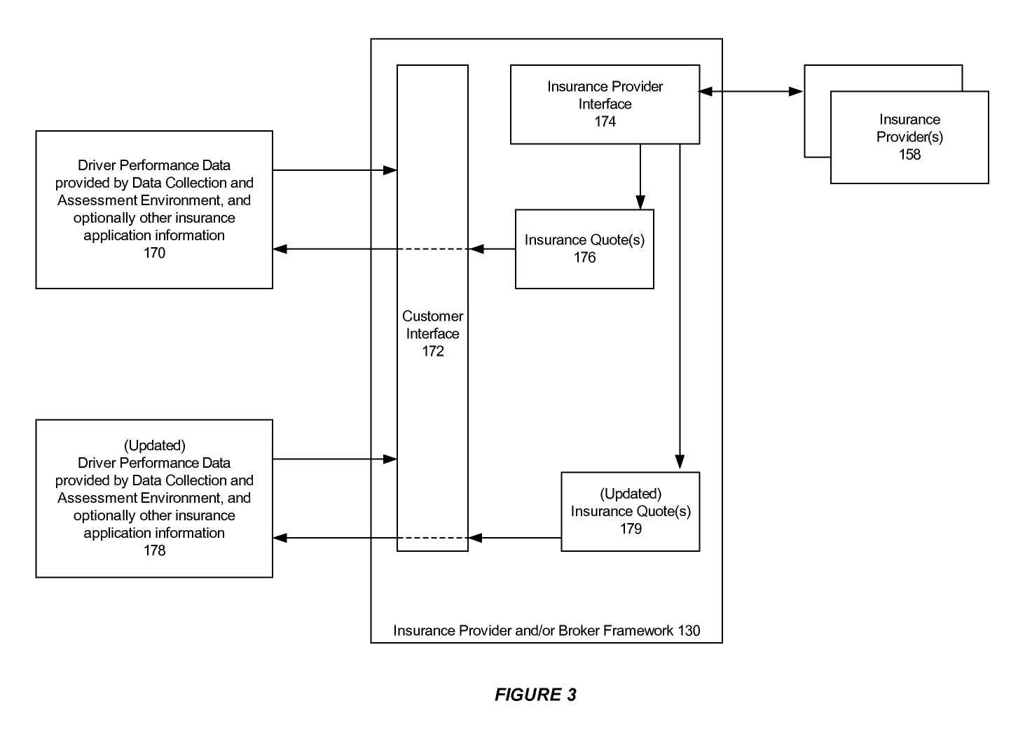

FIG. 3 illustrates use of an insurance provider and/or broker framework, in accordance with an embodiment. As shown in FIG. 3, an insurance provider and/or broker framework includes a customer interface 172 that allows a driver to communicate their driving performance information 170, and an insurance provider interface 174 that enables the insurance provider and/or broker to invite 156 other insurance providers 158 to offer an insurance quote 176 personalized to the driver. As described previously, the information received from a driver's data collection and assessment environment can be secured and/or anonymized prior to determining the driver's insurance quote, or inviting other insurance providers to offer an insurance quote. At a later point in time, the driver can provide updated driver performance data 178, and receive an updated insurance quote(s) 179 as required.

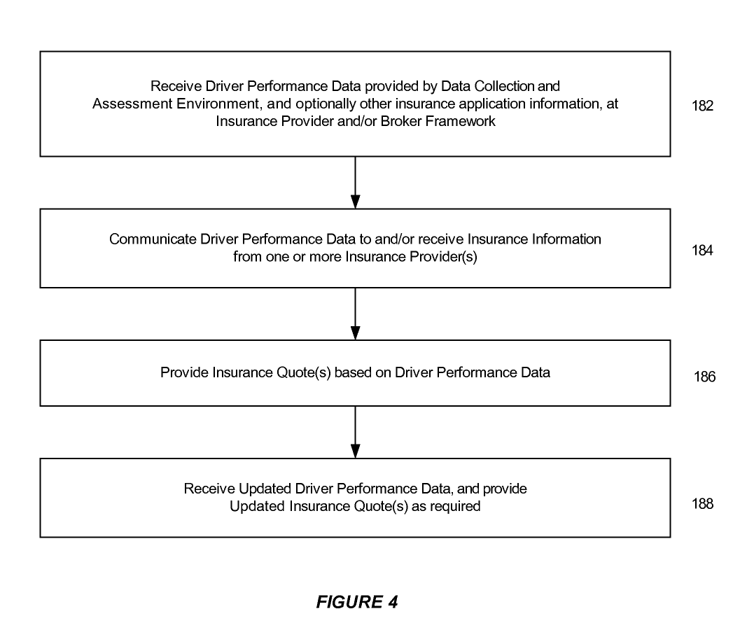

FIG. 4 is a flowchart of a method for characterizing driver performance and use in determining insurance coverage, in accordance with an embodiment. As shown in FIG. 4, at step 182, the system receives driver performance data provided by a data collection and assessment environment, and optionally other insurance application information, at an insurance provider and/or broker framework. At step 184, the system communicates driver performance data to and/or receives insurance information from one or more insurance provider(s). At step 186, insurance quote(s) are provided based on the driver performance data. At step 188, the system can receive updated driver performance data, and provide updated insurance quote(s) as required.

In accordance with an embodiment, a risk score can be calculated on the portable device (e.g., smartphone, PDA, computer or other device) itself. Alternatively, raw data or information can be collected from the portable device and uploaded to a driver rating platform for risk score calculation, resulting in a score that can then either be provided directly to the insurance provider, or reported back to the insured, for their use in applying for insurance coverage.

The present invention may be conveniently implemented using one or more conventional general purpose or specialized digital computers or microprocessors programmed according to the teachings of the present disclosure, or a portable device (e.g., a smartphone, PDA, computer or other device), equipped with a data collection and assessment environment, including one or more data collection devices (e.g., accelerometers, GPS). Appropriate software coding can readily be prepared by skilled programmers based on the teachings of the present disclosure, as will be apparent to those skilled in the software art.

In some embodiments, the present invention includes a computer program product which is a non-transitory storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. For example, although the illustrations provided herein primarily describe embodiments using vehicles, it will be evident that the techniques described herein can be similarly used with, e.g., trains, ships, airplanes, containers, or other moving equipment. It is intended that the scope of the invention be defined by the following claims and their equivalence.

What is claimed is:

1. A system for characterizing vehicle driver performance and use in determining insurance coverage comprising:
a portable device with a data collection and assessment environment, including one or more data collection devices that can be used to capture data and information or otherwise measure vehicle actions, and a data collection and assessment logic;
wherein the data collection and assessment environment is configured to one or both
calculate a risk score or profile for a driver and provide the risk score or profile to the driver, and/or
capture information about the driver's driving performance, and provide the information to an external insurance provider or broker framework to calculate the risk score or profile,
for use in obtaining a usage based insurance quote (UBI) for the driver.

2. The system of claim 1, further comprising a framework which receives information about the driver's driving performance, and uses this information either to determine an insurance quote, or act as a broker/aggregator in inviting other insurance providers to offer an insurance quote.

3. A method of characterizing vehicle driver performance and use in determining insurance coverage comprising:
providing a portable device with a data collection and assessment environment, including one or more data collection devices that can be used to capture data and information or otherwise measure vehicle actions, and a data collection and assessment logic;
wherein the data collection and assessment environment is configured to one or both
calculate a risk score or profile for a driver and provide the risk score or profile to the driver, and/or
capture information about the driver's driving performance, and provide the information to an external insurance provider or broker framework to calculate the risk score or profile,
for use in obtaining a usage based insurance quote (UBI) for the driver.

4. The method of claim 1, further comprising providing a framework which receives information about the driver's driving performance, and uses this information either to determine an insurance quote, or act as a broker/aggregator in inviting other insurance providers to offer an insurance quote.

5. A system for characterizing vehicle driver performance and use in determining insurance coverage comprising:
a framework which receives information about the driver's driving performance, and uses this information either to determine an insurance quote, or act as a broker/aggregator in inviting other insurance providers to offer an insurance quote, including
receiving information from a portable device with a data collection and assessment environment, including one or more data collection devices that can be used to capture data and information or otherwise measure vehicle actions, and a data collection and assessment logic, and
wherein the data collection and assessment environment is configured to one or both
calculate a risk score or profile for a driver and provide the risk score or profile to the driver, and/or
capture information about the driver's driving performance, and provide the information to the framework to calculate the risk score or profile,
for use in obtaining a usage based insurance quote (UBI) for the driver.

6. A non-transitory computer readable medium, including instructions stored thereon which when read and executed by one or more computers cause the one or more computers to perform the steps comprising:
providing a portable device with a data collection and assessment environment, including one or more data collection devices that can be used to capture data and information or otherwise measure vehicle actions, and a data collection and assessment logic;
wherein the data collection and assessment environment is configured to one or both
calculate a risk score or profile for a driver and provide the risk score or profile to the driver, and/or
capture information about the driver's driving performance, and provide the information to an external insurance provider or broker framework to calculate the risk score or profile,
for use in obtaining a usage based insurance quote (UBI) for the driver.
